(19) United States
(12) Patent Application Publication
(10) Pub. No.: US 2016/0197929 A9
(43) Pub. Date: Jul. 7, 2016

(54) AUTHENTICATED INFORMATION EXCHANGE

(71) Applicants: BILLY G. TILLER, Sudan, TX (US); Monty E. Edwards, Sudan, TX (US)

(72) Inventors: BILLY G. TILLER, Sudan, TX (US); Monty E. Edwards, Sudan, TX (US)

(21) Appl. No.: 13/529,987

(22) Filed: Jun. 21, 2012

Related U.S. Application Data
(60) Provisional application No. 61/499,896, filed on Jun. 22, 2011.

(51) Int. Cl. H04L 29/06; G06F 17/30; G06Q 30/00; G06Q 30/02

(52) U.S. Cl. CPC H04L 63/101; G06F 17/30241; G06F 17/30876

(57) ABSTRACT

An authenticated information exchange for creating value in an agricultural producers' information, the exchange including an electronic information storage vault, an authentication protocol, at least one proprietary GIS layer, including a standard land unit, geo-referencing capabilities, gatekeeping programs, and an error resolution protocol.

### CROSS REFERENCE TO RELATED APPLICATIONS

This patent application claims priority to provisional application 61/499,866 filed Jun. 22, 2011 by the present inventors and the same is incorporated hereto in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE DISCLOSED TECHNOLOGY

1. Field of the Invention

The disclosed relates generally to a novel system for an authenticated information exchange, namely in specific industries such as agriculture where numerous vendors or service providers create reports and assimilate data that must then be transmitted to the producer and shared with certain third parties.

2. Description of Related Art

The concept of an information exchange is generally known in the art, although it is less known with respect to specific industries such as agriculture. Even in the broad sense, however, the known information repository systems are limited in their ability to effectively organize and share information among multiple parties, as well as in their ability to control, limit and authenticate third party access.

US Published Application 2010/0256994 entitled Privacy Entitlement Protocols for Secure Data Exchange, Collection, Monitoring and/or Alerting describes systems for providing entitlement controlled levels of collaborative exchange of data using a network of subscribers and publishers. US Published Application 2008/0046292 Platform for Interoperable Healthcare Data Exchange describes linking a plurality of remote applications containing electronic health records in order to, in real-time, collect, process and store health records. Although both describe somewhat similar concepts, neither can be effectively tailored to address the specific needs described herein.

In agriculture, and specifically with the advent of precision agriculture, producers are inundated with a variety of information from each of their many vendors and service providers, such as lenders, processors, brokers, seed companies, spray pilots, cotton gins and crop insurance companies. The producer is engaged in a yearly “paper chase” to retrieve needed reports from each vendor or service provider and then supply certain reports to a third party. As an example, he may receive reports from his processor that he then needs to provide to his banker or crop insurance agent. He expends unnecessary time and energy picking up and dropping off these reports. This outlay of time and energy is compounded when he must track down landlords and obtain signatures prior to sharing reports with certain third parties, such as crop insurance adjusters and insurance agents.

Advances in technology have resulted in a much greater level of accessible information for producers. The information availability has become so vast that it has become nearly unmanageable for producers. Producers need a centralized and secure “vault” in which to store all the producers' information. Equally important is their need to share this information with third parties on an “as needed” basis, in a secure and controllable fashion. A complicating factor is the producer's need to obtain and assimilate the detailed information associated with each unit of his land, in order that he may become a better steward of his land. With the advent of known Geographic Information Systems, land attributes and detailed geographic information can be closely studied on a per unit basis. Although infinitely helpful, GIS data adds an even more overwhelming volume of information to the producer's library.

There is a need for a centralized and secure information vault for producers. Such an information vault needs to be implemented by an exchange and access controlled by the producer, such that it can be accessible for vendors and service providers to contribute information, accessible for third parties to view and retrieve information, and yet remain secure. It should enable the producer to spend less time communicating information among all his third parties. The vault should have the capability to interface with a system to store, retrieve, support and link a diverse variety of information including data, reports, tables, geographic data, maps, images and other pertinent information. The system is a combination of software and processes, both electronic and manual, by which the system can organize the information so the producer can analyze it to make more informed business decisions.

### SUMMARY DISCLOSURE

In accordance with the present invention, an authenticated information exchange is disclosed that is specifically tailored to agricultural producers.

An objective of the disclosure is an authenticated information exchange for an agricultural producer's information and records, including but not limited to data, documents, reports, tables, geographic data, maps and images.

An objective of the disclosure is to enable a producer to securely share information among authenticated third parties, including but not limited to crop insurance agents, suppliers, consultants, and government agencies.

An objective of the disclosure is to provide a secure information vault wherein a producer and/or second party originator can contribute information including but not limited to uploading or originating information related to commodity production and the production process of the agricultural producer's operation.

An objective of the disclosure is to grant authenticated third parties limited access to a portion of the producer's information with minimal or no efforts on the part of the producer.

An objective of the disclosure is to provide an authentication system whereby a producer can control access rights to authenticated third parties for limited access to his stored information.

An objective of the disclosure is to provide an authentication system wherein a producer can verify and allow second party originators to contribute specific information to the producer data vault with minimal or no effort on the part of the producer.

An objective of the disclosure is to analyze and classify a producer's land units with the producer's input and subsequently link information to this identified and defined geographic location to form attributes to the land units in order to enable the producer to make more informed business decisions.

An objective of the disclosure is the creation of value in a producer's information by collecting, storing and classifying the information in a way that preserves its integrity and offers monetization potential in the form of access fees, advertising or other forms of revenue.

An authenticated information exchange for creating value in an agricultural producer's information, the exchange comprising an electronic information storage vault storing and classifying a producer's information; an authentication protocol for limiting access to the vault; at least one proprietary GIS layer, including a standard land unit; a mechanism to geo-reference certain producer information to the standard land unit; an automated mechanism to link geo-referenced information to the standard land unit; a gatekeeper program to enable limited information contribution to the vault by second party originators; an error resolution protocol, and a gatekeeper program to enable limited information retrieval from the vault by authenticated third parties.

A method for an authenticated information exchange for creating value in an agricultural producer's information, the method comprising: establishing an electronic information storage vault storing and classifying a producer's information; programming an authentication protocol for limiting access to the vault; creating at least one proprietary GIS layer, including a standard land unit; creating a mechanism to geo-reference certain producer information to the standard land unit; creating an automated mechanism to link certain geo-referenced information to the standard land unit; programming a gatekeeper program to enable limited information contribution rights to the vault by second party originators; implementing an error resolution protocol, and programming a gatekeeper program to enable limited information retrieval from the vault by authenticated third parties.

A method for classifying and sharing, in a controlled fashion, an agricultural producer's information, the method comprising creating an electronic information storage vault having an authentication protocol wherein the producer controls party access and further where the vault houses at least one proprietary GIS layer, the GIS layer including a standard land unit wherein the producer and second party originators can geo-reference certain producer information to the standard land unit and further where certain geo-referenced information is linked to the standard land unit, the vault including a gatekeeper program to enable limited upload rights to the vault by second party originators, an error resolution protocol to ensure information integrity, and a gatekeeper program to enable limited information retrieval from the vault by authenticated third parties, the method further monetizing the producer's information.

Other advantages of the present invention will become apparent from the following descriptions, taken in connection with the accompanying figures, wherein, by way of illustration and example, an embodiment of the present invention is disclosed.

### BRIEF DESCRIPTION OF THE DRAWINGS

The figures constitute a part of this specification and include exemplary embodiments to the invention, which may be embodied in various forms. It is to be understood that in some instances various aspects of the invention may be shown exaggerated or enlarged to facilitate an understanding of the invention. To enable more thorough understanding of the features and advantages of the present invention, reference is now made to the detailed description of the invention along with the accompanying figures in which:

FIG. 1 is a flowchart in accordance with a preferred embodiment of the invention.

FIG. 2 is a flowchart in accordance with a preferred embodiment of the invention.

FIG. 3 is a flowchart, in accordance with a preferred embodiment of the invention.

FIG. 4 is a flowchart, in accordance with a preferred embodiment of the invention.

FIG. 5 is a flowchart, in accordance with a preferred embodiment of the invention.

FIG. 6 is a flowchart in accordance with a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The disclosed method, system and components have become critical due to the appetite of many third parties to have more detailed information surrounding the producer's agricultural business, and the desire that the information be geo referenced to the producer's production land units. Another factor is the modern day development of precision agriculture which provides producers with more information than they are able to efficiently assimilate and use. The digitization of all types of agricultural information from various service providers has added to the mountains of unorganized information, and in many cases this information is available to the producer and third parties only in paper form. Although the information currently available to producers is beneficial, it is only so to the extent that it can be digested, applied, shared and preferably even monetized. Despite the advent of fax machines and email, it is still a tedious process for the producer to exchange this information among his third parties, especially when he at times must manually retrieve a document from a second party originator (SPO), take it to a landlord for signature and then deliver it to a third party.

In the system, there are two potential originators for any information, one being the producer member and the other being a second party originator. Examples of second party originators include the service providers listed above, such as cotton gins, spray pilots, grain elevators, crop processors, fertilizer dealers, chemical dealers, real estate brokers, accountants, equipment dealers, lenders, approved insurance providers, Farm Service Agency, State Departments of Agriculture, and others who provide goods or services to the producer member in the course of his agricultural production. The second party originator is a second party to a transaction or event with the first party, the producer. The second party originator has the original information and in most instances is the corroborating party which provides integrity to the producer's information. Second party originators, once granted access, by an authentication protocol, are allowed to contribute information, for example by uploading documents or reports or by originating information via data entry or other methods, to the vault. Authenticated third parties (ATP), are consumers in the system. They are not allowed to contribute information, rather they are only allowed to retrieve and view limited information, once granted access by an authentication protocol. The authenticated third party was not a party in the original transaction or event, but the authenticated third party needs the information because of his relationship with the producer. Examples of authenticated third parties include crop insurance agents, seed companies, Farm Service Agency, approved insurance providers, risk management agencies, market research companies, commodity price forecasting companies, and lending institutions. It is common for a party to be a second party originator in one transaction or event, and then be an authenticated third party in another transaction or event.

Using cotton producers as an example, the following is the inefficient information transfer that currently occurs: The cotton gin, an example of a second party originator, compiles and stores production data of each producer in a digital format. Each year they print this information and give a hard copy to the farmer (producer). The farmer picks the hard copy up from the gin and takes it to his crop insurance agent, an example of an authenticated third party. The agent keys in the information from the hard copy into the insurance provider's system for use in loss determination and also for use in the farmer's actual production history. This manual multiple entry system substantially increases the risk for errors. In reality, in the future, this producer could be flagged for an Actual Production History review and the Approved Insurance Provider must appoint a crop insurance adjuster to once again retrieve the multiple years of production records from the insurance agents, processor, or the producer. This example shows the originator of the information as the cotton gin, and in this instance the cotton gin would be the party that could change or revise the production if an error was located.

Clearly producers need not only an information management system, but a means to assimilate and compile critical information from second party originators and also a way to disseminate and share specific pieces of the information in a producer controlled environment with trusted third parties in an efficient manner. Ideally such a system would provide a vehicle for creating value in a producer's information. The producer needs a system to be able to secure and synthesize information from an originator, store the information securely, organize the information in a manner that facilitates use of the information, access and/or share it with authenticated third parties per the producer's discretion.

The disclosed method and system provides the producer with seamless access to his information, while restricting authenticated third parties to producer controlled limited access.

To ensure credibility and integrity of the system, an error resolution protocol exists wherein the original provider of information is the only party that can make changes or revisions to the information. Any party can notify the exchange of an error, but the original provider and originator of the document is the only one who can make changes, which must be done according to the error resolution protocol.

A component of the system is helping the producer identify and understand each unit of his land. Each tract, or unit, of a producer's land is really a mini-manufacturing unit or factory, having a separate location on a map and a unique set of intrinsic values and costs. It is important to identify and analyze each individual unit so that the producer can determine variances in productivity from unit to unit and customize his agricultural business plan for each unit.

The government, through the Farm Service Agency (FSA) has previously identified, within their Geographic Information System (GIS), a basic layer called the Common Land Unit (CLU). According to the United States Department of Agriculture (USDA), a CLU is the smallest unit of land that has a permanent, contiguous boundary, a common land cover and land management, a common owner and a common producer in agricultural land associated with USDA farm programs. CLU boundaries are delineated from relatively permanent features such as fence lines, roads and/or waterways. They have attributes geospatially linked in a database format and also information in a tabular format, which is not geospatially referenced, but it can be queried for each producer.

CLU data is not, however, readily available. The 2008 Farm Bill, H.R. 6124, specifically Section 1619, denied public access to the CLU layer when Congress inserted language limiting the release of the CLU or the accompanying attributes. Although there are groups pushing to restore the public access of the CLU data with the attributes of Field Boundary, Acres, Tract Number, Farm Number, Field Number, Primary Classification of Land Unit Type and Administrating county and state office, it is dubious whether these efforts will be successful.

The producer, though, remains one of the few exceptions to the restrictions and he can continue to access his CLU data. The disclosed system provides a way by which producers can access, analyze, share and use this CLU information in a manageable and efficient manner, adding to their inventory of valuable and relevant information within the producer controlled information system.

The disclosed system includes assisting producers in the creation of producer's Information Service Cooperative, association, alliance or organization which, through contractual agreements with the authenticated information exchange, provides information services to the membership.

The disclosed system will create value from the member's data that can then be monetized through access fees (for example, charged to authenticated third parties or second party originators) and various ancillary revenues from advertising. The producer's information service cooperative may receive a portion of the profits generated from the access to the members' information by authenticated third parties. A portion would also stream back to the producer.

A component of the disclosed system is the compilation of proprietary agricultural production units known as Standard Land Units (SLU's) which are aggregations, dissections, or assimilations of the CLUs. The SLUs are a more manageable way for the producer to store and analyze information on individual production units because the SLU layer is crafted with the producer's input defining his area of economic significance and refined in scope with the use of crop insurance unit structures, and producer's land unit names. During activation of the system, the CLU's will be processed in order to create SLUs that will be the basic land unit structure for the geospatial referencing of any information in the system, accessible to the producer and his chosen authenticated third parties. The SLU layer will also be the land unit structure utilized by second party originators when they contribute information that will be enhanced with geospatial linking. The disclosed system will also retain the CLU layer for use by the producer.

In practice a component of the disclosed system will be an online GIS, which will act as the graphic user interface (GUI). The producer will sign in and authenticate himself as an authorized user at the portal site. Once sign in is complete, and the producer has opened the GIS portion of the system, a map from the GIS will populate with this producer's land unit data. The SLU will seem to the viewer to be a file drawer as the information or data attributes are geo-referenced to the SLU. As an example, for cotton production, the gin accounts (linking production data) will be linked to the SLU.

To start, the producer member, as a member of the information services cooperative, will allow the exchange to gain access to the producer's CLU layer. The producer, using tools of, and in conjunction with, the exchange will aggregate, dissect, or in some cases assimilate the CLU data into SLU's (the SLUs being the unique and proprietary polygons created from the CLU's that are further explained by alphanumeric identifiers that identify the farm). Processor account numbers and/or unique identifiers related to the geographic location of the SLU will be linked to the SLU, as will the Multiple Peril Crop Insurance unit nickname for the SLU.

The authenticated information exchange, in the preferred embodiment, is managed by a system of software and services where an agricultural producer's information is initially originated by the producer and/or authenticated second party originators, securely stored, organized in a proprietary system, utilized as a major aspect of the producer's internal management system, and then shared externally, with the producer's permission, with authenticated third parties (ATP). Access to the system, which includes the server based information vault, is enabled by a proprietary interface operating in a remote and mobile means utilizing a secure access portal available with internet access. Internet is meant to be inclusive of all those features that constitute mobile and remote access including but not limited to virtual private networks, cloud computing, and for instance remote desktop. The entire exchange is closed, secure, proprietary, and only available to authenticated subscribers. The means of authentication will include but not be limited to a user name and password, biometrics, or some other future means of authentication.

While producer members will have full access in the exchange, authenticated facilitating parties will have only limited ability to contribute in the case of second party originators or retrieve information in the case of authenticated third parties. The exchange is “producer controlled” in that the producer determines the level, if any, of access the authenticated third party may be granted to access the producer's information. The premium version may allow the producer to file notations and documents geo referenced to the appropriate SLU's. He would also have the ability to store within his vault important documents, records, and notations that were general in nature and not specifically geo referenced.

With regard to the facilitating parties, which are known within the disclosed system as authenticated third parties and second party originators, a novel authentication process is a component of the disclosed system. First, the facilitating party must be authenticated by the exchange administrator, as part of the services offered to the member/producer. At this access entry point, the process may be manual to assure the credibility of the facilitating party. The exchange screens the facilitating parties to determine if they indeed have a valid business reason for being allowed access to the producer member. Once they have been screened (authenticated), they become visible to the producer. At this stage the facilitating party still cannot actually deliver or retrieve any producer data. He can only request a “handshake with the producer” from the producer/member. The producer member can grant a second party originator the right to contribute information to the repository on the producer's behalf. The producer member can allow or deny an authenticated third party access to his information within the exchange. He can also limit what the third party can access or do by selecting from a variety of permission levels. He can even limit the amount of time the authenticated third party can access his system.

Once authenticated by the exchange and permitted access by the producer/member, the second party originator may proceed to contribute information to the producer's account, for example, a cotton gin once authenticated and permitted access could contribute production reports. Part of the value in this system is that the information, because it is being contributed (uploaded or originated) directly by the originating party, cannot be falsified or altered, but rather is clean, credible information, much in the way that financial data is reported by financial institutions to credit agencies. A component of the disclosed system is a method or process through which disclosed erroneous information is routed back to the originator if corrections are warranted. Second party originator's authenticated rights can be terminated if the originator is found to be contributing erroneous information on a continuous basis. The value of the exchange is created by competent, certifiable, accurate and organized information.

The contributed information, for example, production records, custom applied chemical records, crop insurance records, FSA data and member notations, can be geo-referenced to the producer's SLUs. The geo-referencing could happen in various ways. One mechanism may be in the form of manual data entry. Another mechanism may be in the form of software performing an automated task. In the preferred method, the system will query the producer as to whether he wishes to link newly originated information to an existing SLU. If he answers affirmatively, the system displays a map of his SLU layer. He can then click on the SLU that corresponds to the information and the system will attach the SLU identifier in a field in the metadata of the information (geo-tagged). The producer can also upload geo-tagged information. The system will look for the geo tag and determine which SLU the GIS coordinates lie within. If the geo tag is the SLU identifier in the appropriate field then the system will recognize the link to the SLU.

The exchange may also develop products that are enhancements by combining the information from a series of originators that can be sold to an ATP. As an example, large biotech seed companies often need several pieces of data to complete a seed rebate to a cotton producer when the producer's crop is destroyed early in the growing season. The producer is refunded his technology fee from the seed company when the seed company receives the needed information which may include crop insurance loss data from the adjuster's worksheet, the planted acreage via the updated CLU data or the crop insurance data, failed cotton acreage via form FSA-576, the seed invoices via the seed vendor's invoice, and the biotechnology seed planted on these acres via the seed vendor or the producer/member. The seed company may also require chemical invoices as well as documentation of the premium seed. All this data could be part of the producer's file within the exchange and the necessary information could easily be made available to the seed company with a few clicks by the producer, as opposed to days amassing the information and transporting it to the seed company.

Another novel aspect will be a concept where a document is created through a template and this document does not reside in the exchange until it is accessed. It is a template that has fields which are populated from database data that resides in the exchange. Once accessed by a producer/member or a subscriber, the fields populate and this document is available for print by the interested party. This may be a way to provide the above described information to the seed company without providing them access to the producer's information.

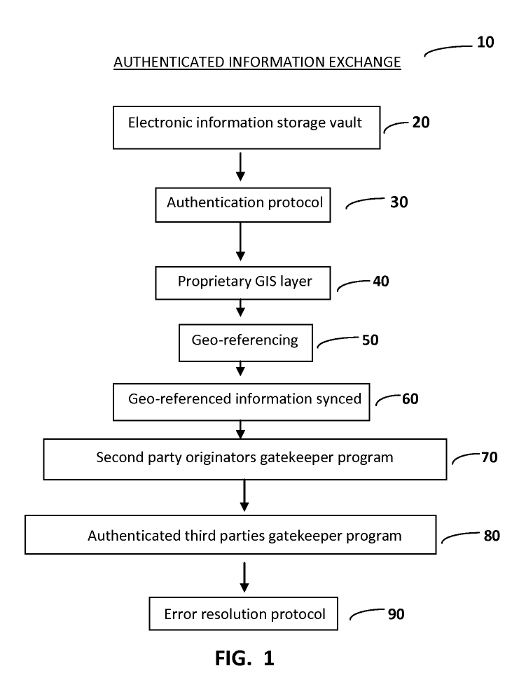

Turning to the figures, FIG. 1 is a flowchart showing the general flow of the disclosed authenticated information exchange 10. The exchange utilizes an electronic information storage vault 20 in which to securely house the information contributed by the second party originators and producer member. In order to further ensure security and reliable access, an authentication protocol 30 is utilized, to govern who is allowed access to the exchange. A proprietary GIS layer 40 is created in the exchange, specific to each producer member's land. Geo-referencing 50 is utilized to identify and organize land units. The geo-referenced information is synced 60 to applicable information. A second party originators gatekeeper program 70 coordinates what types of access a second party originator is entitled to, for example their contribution rights. An authenticated third parties gatekeeper program 80 coordinates what types of access an authenticated third party is entitled to, for example what information they may retrieve. An error resolution protocol 90 exists to ensure the integrity of the housed information.

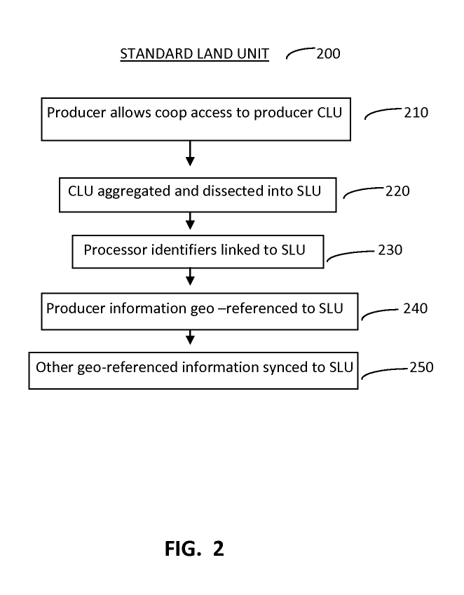

Turning to FIG. 2, the GIS layer includes the creation of a standard land unit 200. To enable this, the producer, upon becoming a member of the exchange, allows the cooperative access to his existing CLUs 210. Software and services of the exchange are used by the producer to aggregate and dissect the CLU into an SLU 220. Processor identifiers are linked to the SLU 230. Producer information is geo-referenced to the SLU 240. Other geo-referenced information is then linked (synced) to the SLU 250. For example, the exchange or producers can inform the second party originators of how to geo-tag an information item. Upon the second party originator contributing it to the exchange, software would automate the process. For instance a field of information within the record or a field in the metadata would either have a GIS coordinate that the system would utilize to identify the appropriate SLU or the field could contain the SLU identifier.

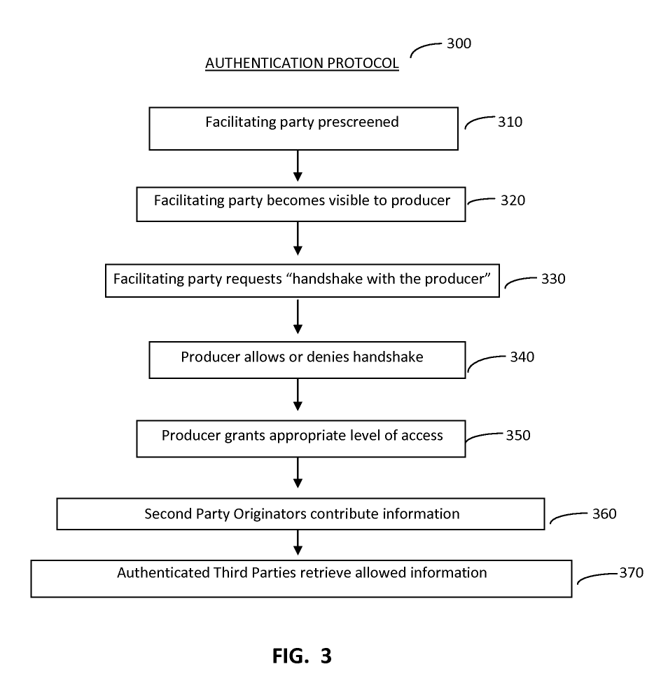

In FIG. 3, the authentication protocol 300 is described. Facilitating parties include both second party originators and authenticated third parties. To begin, the facilitating party is prescreened 310 by the exchange. This prescreening is performed by the exchange to ascertain who the party is, what type of access they are seeking and whether they appear to be credible. If the prescreen is successful, the facilitating party becomes visible to the producer 320 via a program or online notification. The facilitating party then requests a “handshake with the producer” 330. The producer may allow or deny the handshake 340. If the producer allows the handshake, he then may proceed to grant the appropriate level of access 350. For example, if the facilitating party qualifies as a second party originator, the producer will grant information contribution rights. If the facilitating party qualifies as an authenticated third party, the producer will grant information retrieval rights. The producer may further limit the extent or type of contribution or retrieval rights. Once access is granted, second party originators may begin contributing information 360. Similarly, authenticated third parties may begin retrieving allowed information 370. The producer member will retain the right and ability to further limit or revoke future access.

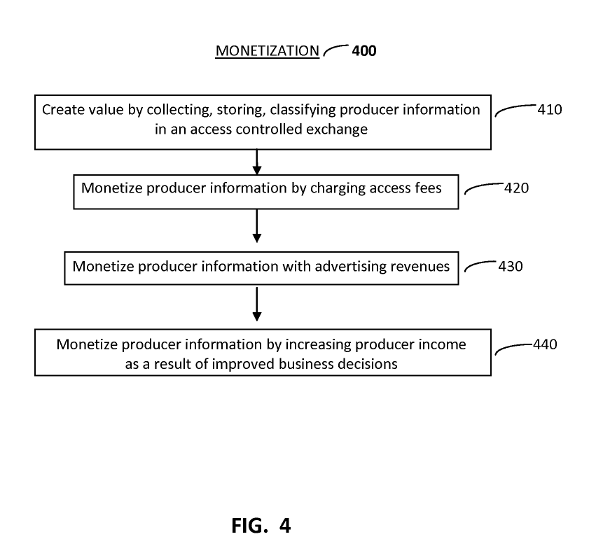

FIG. 4 outlines the process by which a producer member's information may be monetized for his benefit, as well as the benefit of the exchange. The exchange enables monetization 400 by collecting, storing and classifying producer information in an access controlled exchange 410. The exchange can then monetize producer information by charging access fees 420, for example to authenticated third parties who need to be able to retrieve information. The exchange can monetize producer information with advertising revenue 430, for example by selling advertising space to second party originators, authenticated third parties, or others. The exchange further monetizes producer information by increasing producer income as a result of improved producer business decisions 440.

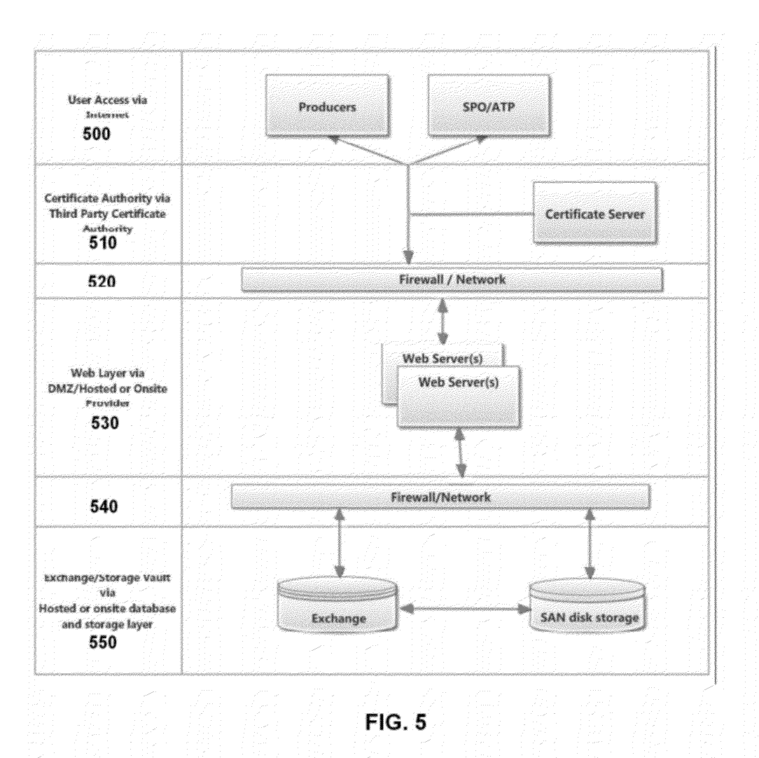

In FIG. 5 is illustrated the layers of information technology that enable the exchange to function. In the first layer, users, including producers, second party originators and authenticated third parties access the system via the internet 500. They may do so via computer, mobile phone, tablet or other available means. A certificate authority 510 housed in a certificate server ensures site credibility or domain validation. A firewall or network 520 exists between this layer and the web layer 530, which is housed on web servers using DMZ/hosted or onsite providers. A second firewall or network 540 resides between this layer and the exchange storage vault 550 which may also utilize SAN disk storage or other appropriate storage means.

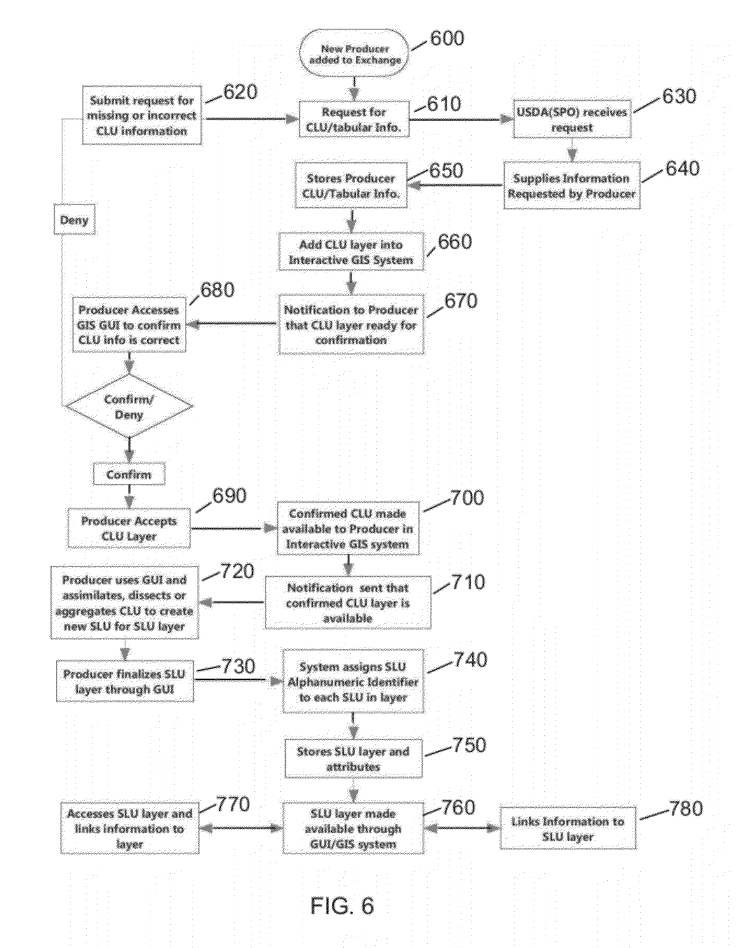

FIG. 6 illustrates in more detail the process of creating the SLU layer using the CLU layer. Tabular information is additional information that can be geo-tagged. In the figure, the producer, who is a member of the information services cooperative, is added to the exchange 600. The system makes a request for the CLU/tabular information 610. The producer may also submit a request for missing or incorrect CLU information 620 (usually from the United States Department of Agriculture or USDA). The USDA, which may be authenticated as a second party originator receives the request 630 and supplies the information 640 and the exchange stores the producer CLU/tabular information 650. The exchange adds the CLU layer into the GIS system 660 and sends a notification to the producer that the CLU layer is ready for confirmation 670. The producer accesses the GIS GUI to confirm that the CLU information is correct 680. If confirmed, the producer accepts the CLU layer 690. The confirmed CLU is made available to the producer in the interactive GIS system 700. The exchange sends notification that the confirmed CLU layer is available 710 and the producer uses the GUI to assimilate, dissect or aggregate the CLU to create a new SLU for the SLU layer 720. The producer finalizes the SLU layer through the GUI 730. The exchange then assigns an SLU alphanumeric identifier to each SLU in the layer 740 and stores the SLU layer and attributes 750. The SLU layer is made available through the GUI/GIS system 760. The producer can then link (sync) information, including but not limited to reports, documents, maps, images, tables and other information to the layer 770. Similarly, the second party originators can link information to the SLU layer 780.

In summary, the disclosed exchange and system will offer significant advantages and opportunities to the producer. One advantage is that the exchange allows the producer member full access to the vault and the GIS layers, for his use as a management information system, yet much of the information found therein has been contributed by second party originators at no expense or effort by the producer. Rather than the producer having to collect all of this information from his various service providers, he is able to, by virtue of his membership to the exchange, have it contributed to his vault for him, and potentially even monetized for him. The system is advantageous for the producer member, the second party originators, and the authenticated third parties, in that it enables secure access to information that is credible and trustworthy.

Envisioned are both a free base product and a premium priced product to offer choices to subscribers. The system as described herein can also be used in other industries, outside of agriculture, for example with regard to healthcare records or other industries requiring a large volume of data production and exchange.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It is to be understood that the embodiments disclosed herein are shown for illustrative purposes and are not intended to be construed as limitations of the disclosed method and system. Those skilled in the art will recognize or be able to ascertain in the course of routine experimentation, that variations and equivalents of the embodiments may be undertaken without departing from the scope of the invention.

Certain terms are used throughout the description to refer to particular method components. As one skilled in the art will appreciate, design and manufacturing companies may refer to a component by different names. This document does not intend to distinguish between components that differ in name but not function.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

The use of the word “a” or “an” when used in conjunction with the word “comprising” may mean “one”, or may also mean “one or more.” The use of the term “or” in the claims is used to mean “and/or” unless explicitly indicated to refer to alternatives only or the alternatives are mutually exclusive, although the disclosures supports a definition that refers to only alternatives and “and/or.”

The methods and systems disclosed and claimed herein can be made and executed without undue experimentation based on the level of disclosure presented. While the methods and systems have been described in terms of their preferred embodiments, it will be apparent to those skilled in the art that they are not limited to the exact steps described and may vary from such description without departing from the scope and spirit of the invention. The substitutes and modifications employed by one skilled in the art are deemed to fall within the scope of the invention.

What is claimed is:

1. An authenticated information exchange for creating value in an agricultural producers' information, the exchange comprising:
an electronic information storage vault storing and classifying a producer's information;
an authentication protocol for limiting access to the vault;
at least one proprietary GIS layer, including a standard land unit;
a mechanism to geo-reference certain producer information to the standard land unit;
an automated mechanism to link geo-referenced information to the standard land unit;
a gatekeeper program to enable limited information contribution to the vault by second party originators;
an error resolution protocol, and
a gatekeeper program to enable limited information retrieval from the vault by authenticated third parties.

2. The exchange of claim 1 wherein information is selected from the group consisting of producer data, reports, images, documents, tables, geographic data and maps.

3. The exchange of claim 1 wherein the authentication protocol allows a party limited access for the purpose of asking the producer to grant retrieval or contribution rights.

4. The exchange of claim 1 where at least one of the elements are controlled by software.

5. The exchange of claim 1 wherein value is created by monetizing a producer's information through access fees.

6. The exchange of claim 1 wherein value is created by developing advertisement revenues.

7. The exchange of claim 1 wherein value is created by classifying and indexing producer information such that the producer can make more informed business decisions.

8. The exchange of claim 1 wherein the standard land unit is created by aggregating and dissecting information from a common land unit having alpha numeric identifiers.

9. A method for an authenticated information exchange for creating value in an agricultural producer's information, the method comprising:
establishing an electronic information storage vault storing and classifying a producer's information;
programming an authentication protocol for limiting access to the vault;
creating at least one proprietary GIS layer, including a standard land unit;
creating a mechanism to geo-reference certain producer information to the standard land unit;
creating an automated mechanism to link certain geo-referenced information to the standard land unit;
programming a gatekeeper program to enable limited information contribution rights to the vault by second party originators;
implementing an error resolution protocol, and
programming a gatekeeper program to enable limited information retrieval from the vault by authenticated third parties.

10. The method of claim 9 wherein information is selected from the group consisting of producer data, reports, images, documents and compilations.

11. The method of claim 9 wherein the authentication protocol allows a party limited access for the purpose of asking the producer to grant retrieval or contribution rights.

12. The method of claim 9 where at least one of the elements are controlled by software.

13. The method of claim 9 wherein value is created by monetizing a producer's information through access fees.

14. The method of claim 9 wherein value is created by developing advertisement revenues.

15. The method of claim 9 wherein value is created by classifying and indexing producer information such that the producer can make more informed business decisions.

16. The method of claim 9 wherein the standard land unit is created by aggregating and dissecting information from a common land unit having alpha numeric identifiers specific to the geographic location.

17. A method for classifying and sharing, in a controlled fashion, an agricultural producer's information, the method comprising creating an electronic information storage vault having an authentication protocol wherein the producer controls party access and further where the vault houses at least one proprietary GIS layer, the GIS layer including a standard land unit wherein the producer and second party originators can geo-reference certain producer information to the standard land unit and further where certain geo-referenced information is linked to the standard land unit, the vault including a gatekeeper program to enable limited upload rights to the vault by second party originators, an error resolution protocol to ensure information integrity, and a gatekeeper program to enable limited information retrieval from the vault by authenticated third parties, the method further monetizing the producer's information.

18. The method in claim 17 wherein second party originators can contribute information to the vault.

19. The method in claim 17 wherein authenticated third parties have limited retrieval rights directed toward information in the vault.

20. The method of claim 17 wherein the standard land unit is created by aggregating and dissecting information from a common land unit having alpha numeric identifiers specific to the geographic location.
